(19) United States
(12) Patent Application Publication
(10) Pub. No.: US 2008/0196523 A1
(43) Pub. Date: Aug. 21, 2008

(54) Dustproof Device for a Ball Screw

(76) Inventor: Chia-Min LIU, Taichung (TW)

Correspondence Address: Dr. BANGER SHIA, 102 Lindencrest Ct., Sugar Land, TX, 77479-5201, US

(21) Appl. No.: 11/676,267

(22) Filed: Feb. 16, 2007

(51) Int. Cl. F16J 15/32

(52) U.S. Cl. 74/89.4; 277/423; 277/549

(57) ABSTRACT

A dustproof device for a ball screw disposed on an end surface of a nut comprises: an absorber, an oil scraping piece and a wiping member. The absorber is made of liquid-absorbing material. The oil scraping piece has an oil scraping portion contacting the surface of the screw. The wiping member is formed with a threaded portion for meshing with the surface of the screw. And a plurality of protrusions is formed between the wiping member and the oil scraping piece for defining at least one radial through hole between the wiping member and the oil scraping piece. Therefore, the dustproof device can block and remove powder and liquid, and prevent lubricant leakage out of the nut and can absorb a tiny amount of cutting fluid passing through the oil scraping piece.

### BACKGROUND OF THE INVENTION

1. Field of the Invention

The present invention relates to a component for a ball screw, and more particularly to a dustproof device for a ball screw which is capable of blocking and removing powder and liquid, and preventing lubricant leakage.

2. Description of the Prior Art

Nowadays, ball screw is used more and more widely in modern industries. In addition to the effect of high precision, the linear transmission device also has the advantages of low frictional loss, high energy conversion ratio, low noise and high rigidity. Hence, it is self-evident that the ball screw is very important to various industrial mechanisms.

To enable the balls between the screw and the nut to circulate endlessly and to relieve the stress thereof, the existing ball screw is usually provided with various dustproof devices at both ends of the nut. And all the dustproof designs have their own disadvantages. For this matter, the existing dustproof device needs a better solution.

FIGS. 1-4 show various known dustproof devices.

FIG. 1 shows a dustproof device disclosed in U.S. Pat. No. 6,578,852, and the dustproof device is a thin scraper 10 disposed in the nut, on the inner edge of the scraper 10 is formed a soft protrusion 11 to be abutted against the threads of the nut, thus providing a dust-scraping function. However, the problem of this dustproof device is that its effect of blocking the iron chips is poor, and the soft protrusion 11 is very likely to be cut or damaged by the hard iron chips, and as a result, the scraper 10 will lose its dustproof function.

FIG. 2 shows a dustproof device disclosed in U.S. Pat. No. 2,793,538, which is a barrel-type scraper 12 with grooves 121, when the barrel-type scraper 12 is threaded on the screw 13, the grooves 121 serve to push away the dust. The problem of this scraper is that it is only suitable for removing large dust particles but its effect of removing small dust particles or liquid is not ideal.

FIGS. 3 and 4 show a dustproof device disclosed in U.S. Pat. No. 6,732,599, which is a multi-piece type scraper comprising a base 14, a plurality of annular scraping pieces 15 and a clasp 16. The clasp 16 makes the annular scraping pieces 15 abut closely against the screw to scrape off the small dust particles. And the problem of this scraper is that it doesn't have the liquid-proof function.

In addition to the abovementioned respective problems, these three conventional techniques also have the common disadvantages as follows:

The use of the scraper is to prevent the invasion of foreign objects, to make up the machining error and prevent the scraper from excessively interfering with the screw there must be an interval between the scraper and the screw. Therefore, the various scrapers sold on the market can't remove the small dust particles and the liquid. When the ball screw is used in a precision machining center, the small iron particles and the cutting fluid will enter the nut, and adversely affect the service life of the ball screw. Despite the aforementioned scrapers have been improved in terms of the iron-dust discharging effect, they cannot prevent the cutting fluid from entering the nut.

To effectively solve the aforementioned problems, the inventor of the present invention, on the basis of the accumulated experience and skills associated with the linear transmission field, has developed a brand new dustproof device for a ball screw.

### SUMMARY OF THE INVENTION

The primary objective of the present invention is to provide a dustproof device for a ball screw which is capable of blocking and removing powder and liquid.

The secondary objective of the present invention is to provide a dustproof device for a ball screw that prevents lubricant from leaking out of the nut and absorbs a tiny amount of cutting fluid passing through the oil scraping piece.

To obtain the abovementioned objectives, the dustproof device for a ball screw in accordance with the present invention comprises: an absorber, an oil scraping piece and a wiping member. The absorber is made of liquid-absorbing material. The oil scraping piece has an oil scraping portion contacting the surface of the screw. The wiping member is formed with a threaded portion for meshing with the surface of the screw. And a plurality of protrusions is formed between the wiping member and the oil scraping piece for dividing the space between the wiping member and the oil scraping piece into at least one radial through hole.

### BRIEF DESCRIPTION OF THE DRAWINGS

FIG. 1 is a cross sectional view of a conventional dustproof device for a ball screw disclosed in U.S. Pat. No. 6,578,852;

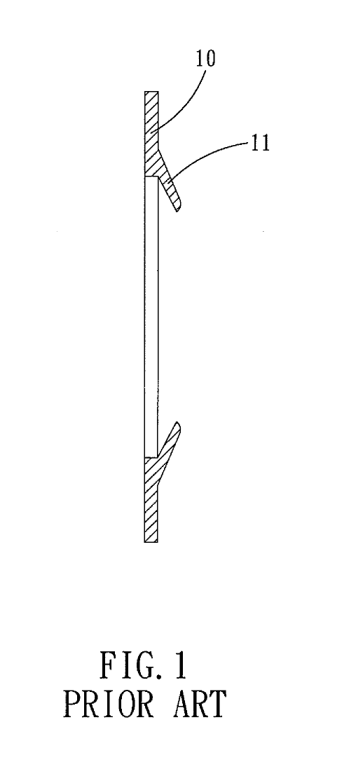

FIG. 2 is a perspective view of a conventional dustproof device for a ball screw disclosed in U.S. Pat. No. 2,793,538;

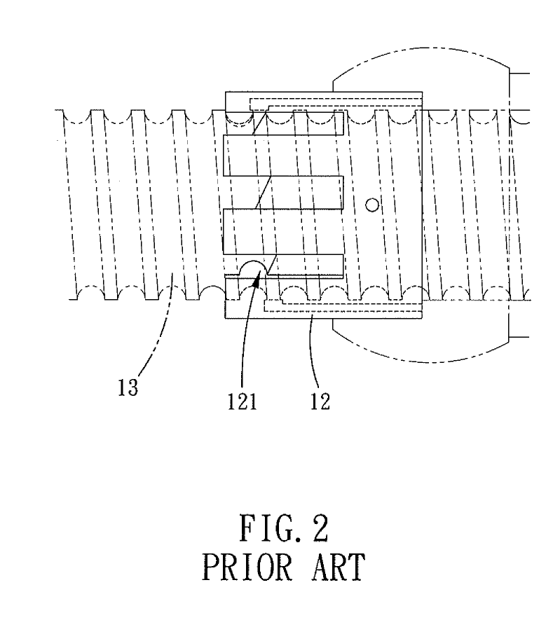

FIG. 3 is a plan view of a conventional dustproof device for a ball screw disclosed in U.S. Pat. No. 6,732,599;

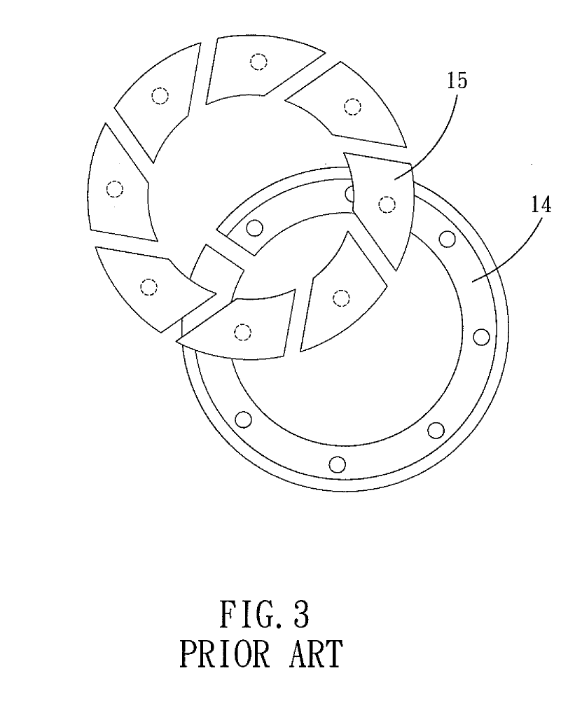

FIG. 4 is an exploded view of the conventional dustproof device for a ball screw disclosed in U.S. Pat. No. 6,732,599;

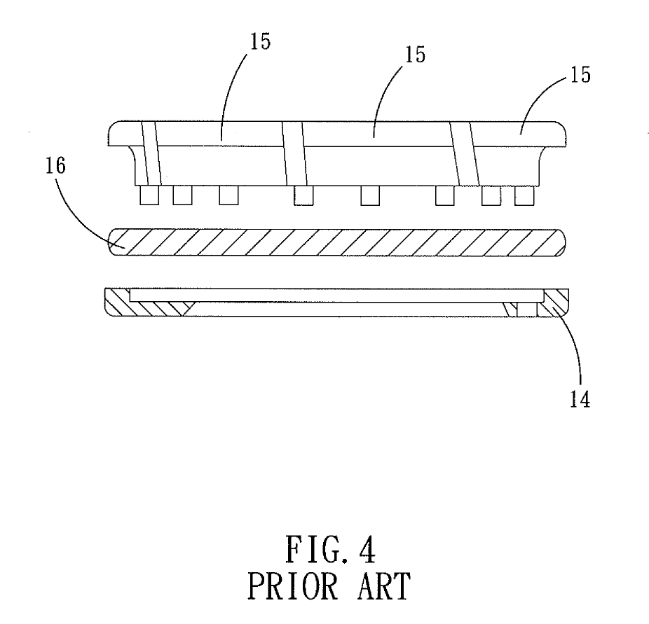

FIG. 5 is an exploded view of a dustproof device for a ball screw in accordance with a first embodiment of the present invention;

FIG. 6 is a cross sectional view of the dustproof device for a ball screw in accordance with the first embodiment of the present invention;

FIG. 7 is a perspective view of an oil scraping piece in accordance with the first embodiment of the present invention;

FIG. 8 is an exploded view of a dustproof device for a ball screw in accordance with a second embodiment of the present invention;

FIG. 9 is a cross sectional view of the dustproof device for a ball screw in accordance with the second embodiment of the present invention; and

FIG. 10 is a wiping member in accordance with the second embodiment of the present invention.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

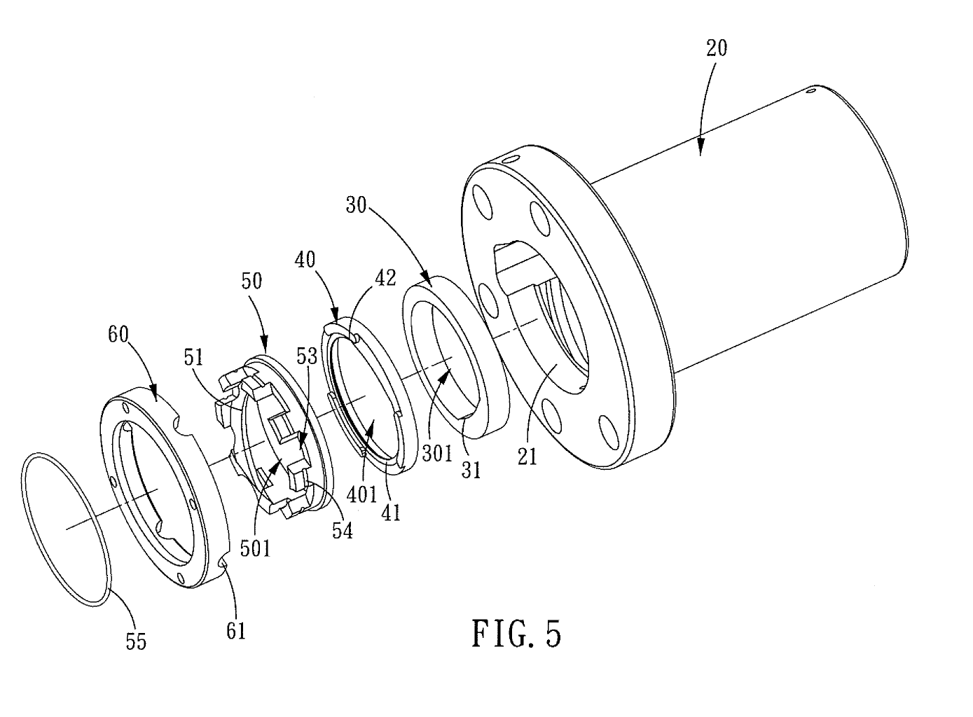

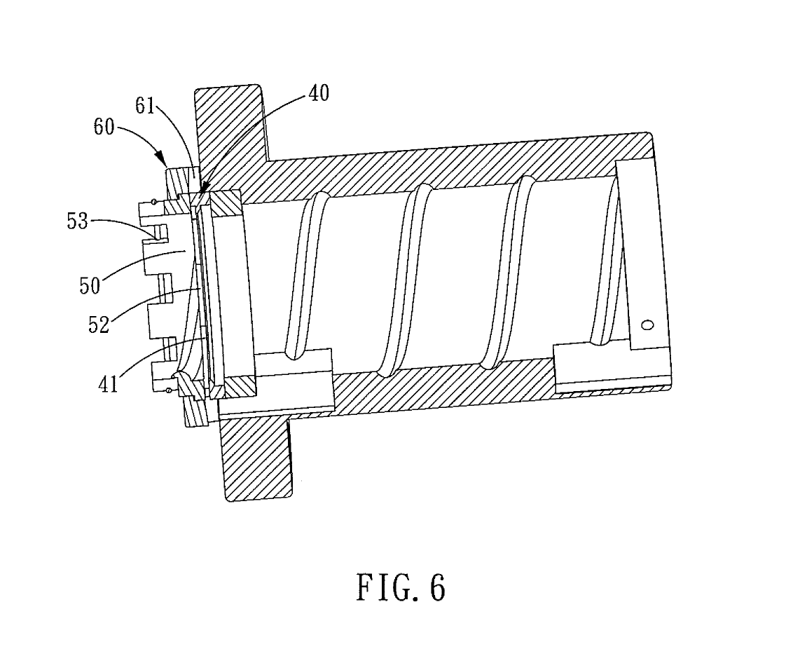

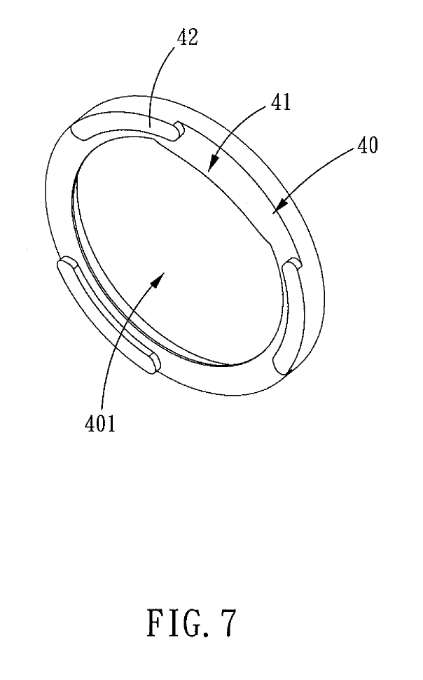

Referring to FIGS. 5-7, a dustproof device for a ball screw in accordance with a first preferred embodiment of the present invention is disposed in a receiving groove 21 in an end surface of a nut 20 and comprises, successively from the outside in: an absorber 30, an oil scraping piece 40, a wiping member 50 and a cover 60.

The absorber 30 is made of liquid-absorbing material (such as: non-woven fabric, sponge, felt, or porous plastic), in the center of the absorber 30 is formed a receiving hole 301 for passage of the screw. The absorber 30 has a protrusion 31 contacting the surface of the screw. The receiving hole 301 is equal to or slightly smaller than the cross section of the screw.

The oil scraping piece 40 is made of rubber and is mounted outside the absorber 30. Formed in the center of the coil scraping piece 40 is a receiving hole 401 for insertion of the screw. At a first end surface of the oil scraping piece 40 is formed a soft protruding oil scraping portion 41 for contacting the surface of the screw, and on a second end surface of the oil scraping piece 40 are formed three protrusions 42 that are equidistantly arranged around the axis of the screw. The thickness of the oil scraping piece 40 is smaller than that of the absorber 30.

The wiping member 50 is located outside the oil scraping piece 40, and in the center of the wiping member 50 is formed a receiving hole 501 for passage of the screw. The wiping member 50 is provided with a threaded portion 51 for meshing with the surface of the screw. The protrusions 42 of the oil scraping piece 40 are evenly abutted against the inner surface of the wiping member 50, thus forming three radial through holes 52 between the wiping member 50 and the oil scraping piece 40. In the threaded portion 51 are defined a plurality of discharging grooves 53 for discharging chips, and in the outer periphery of the respective discharging grooves 53 is formed an annular groove 54 for installation of an elastic member 55 to make the threaded portion 51 of the wiping member 50 abut closely against the surface of the screw.

The cover 60 is made of metal material and mounted outside the absorber 30, the oil scraping piece 40 and the wiping member 50, such that the cover 60 cooperates with the nut to fix the absorber 30, the oil scraping piece 40 and the wiping member 50. In the cover 60 are formed with radial grooves 61 for discharging liquid by the cooperation of the radial through holes 52 between the wiping member 50 and the oil scraping piece 40.

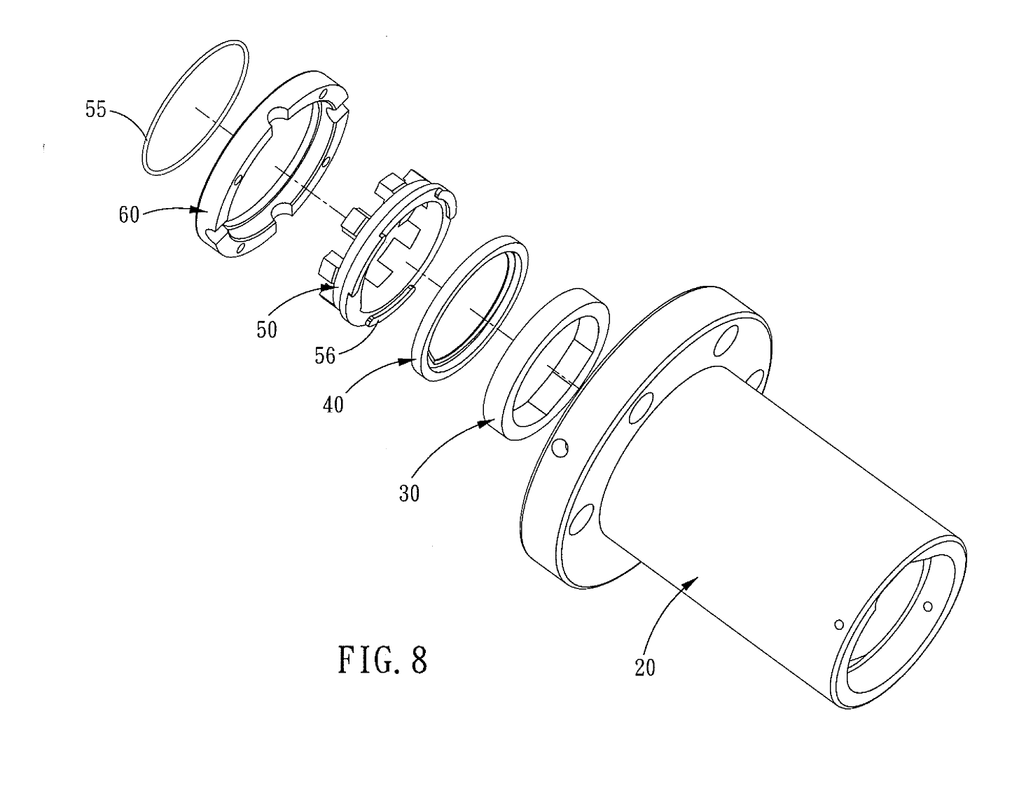

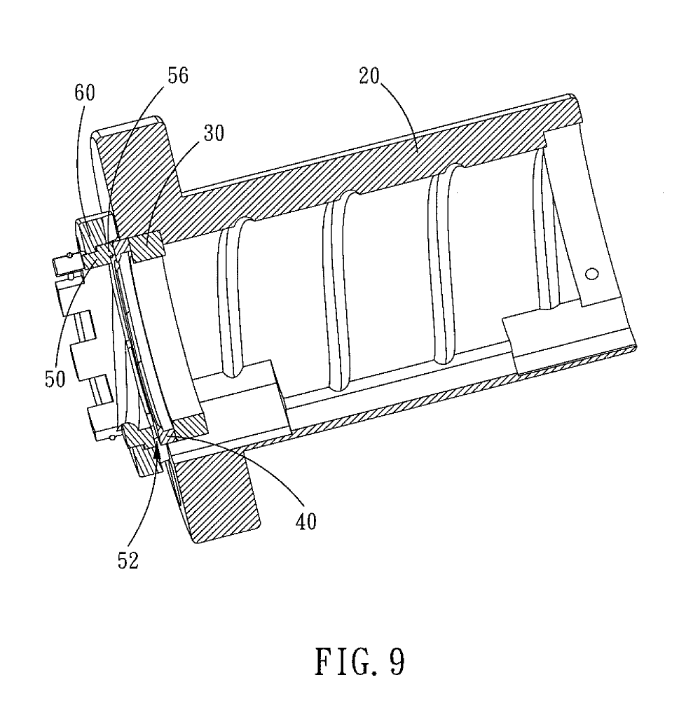

FIGS. 8 and 9 show a dustproof device for a ball screw in accordance with a second preferred embodiment of the present invention, which comprises an absorber 30, an oil scraping piece 40, a wiping member 50, a cover 60 and an elastic member 55, orderly assembled in the receiving groove 21 in an end surface of the nut 20. The protrusions 42 of the first embodiment are changed to be the protrusions 56 and relocated to the inner surface of the wiping member 50, and such an arrangement can also create a plurality of radial through holes 52 between the wiping member 50 and the oil scraping piece 40. Therefore, the two embodiments are the same in terms of technique characteristic.

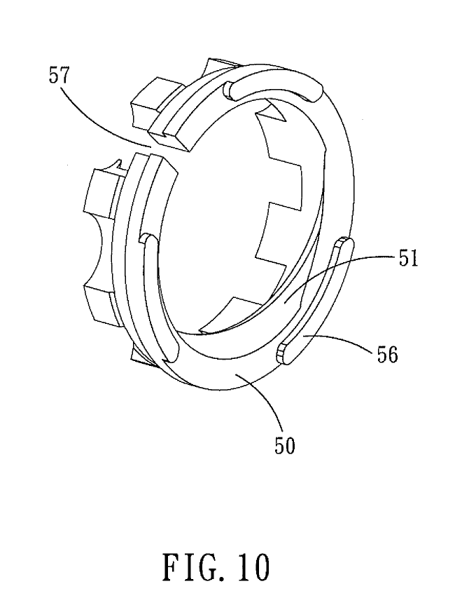

With reference to FIG. 10, the wiping member 50 in accordance with the present invention can be a closed ring structure as mentioned in the previous embodiment, and can also be a C-shaped structure with a gap 57, as shown in FIG. 10.

For a better understanding of the characteristics of the present invention, the improvements of the present invention relative to the conventional technique are summarized as follows:

After an absorber 30, an oil scraping piece 40, a wiping member 50, a cover 60, and an elastic member 55 are disposed on the nut 20, since the plurality of discharging grooves 53 is formed in the threaded portion 51 for discharging chips, plus the elastic member 55 makes the threaded portion 51 of the wiping member 50 abut more closely against the surface of the screw, the present invention is effective both in removing and blocking small and large iron particles.

The oil scraping piece 40 is formed with the soft protruding oil scraping portion 41 whose rubber material is very effective in preventing passage of liquid, thus it not only can prevent the entrance of cutting fluid into the nut, but also the radial through holes 52 between the wiping member 50 and the oil scraping piece 40 and the radial grooves 61 of the cover 60 can allow the liquid to be discharged out of the dustproof device. Further, the oil scraping piece 40 can prevent lubricant from leaking out of the nut 20.

Finally, the absorber 30 is made of liquid-absorbing material (such as: non-woven fabric, sponge, felt, or porous plastic), it can maintain a certain amount of lubricant and absorb a tiny amount of cutting fluid passing through the oil scraping piece.

It is to be noted that the oil scraping piece is usually loosely engaged with the receiving groove of the nut, to prevent liquid from entering the nut through the interval therebetween, a plastic piece (not shown) can be additionally disposed on the outer surface of the oil scraping piece for preventing the entrance of liquid into the oil scraping piece.

To summarize, the wiping member of the present invention is used to block and discharge the iron chips and dusts produced during cutting and machining process, the oil scraping piece is to stop the cutting fluid from entering the nut, and the absorber serves to absorb the cutting fluid passing through the oil scraping piece. Radial through holes are defined between the wiping member and the oil scraping piece by the protrusions, so that the wiping member and the oil scraping piece will not fully abut against each other And the radial through holes will cooperate with the radial grooves of the cover to define a discharging passage for discharging the cutting fluid. Further, since the oil scraping piece is higher than the end surface of the nut, the cutting fluid will not flow back through the radial through hole of the cover. And finally the wiping member, the oil scraping piece, and the absorber are fixed to the nut by the metal cover.

While we have shown and described various embodiments in accordance with the present invention, it is clear to those skilled in the art that further embodiments may be made without departing from the scope of the present invention.

What is claimed is:

1. A dustproof device for a ball screw being mounted on an end surface of a nut, and comprising:
an oil scraping piece having a first end surface abutted against the end surface of the nut, on the first end surface being formed an oil scraping portion for contacting a surface of a screw of the ball screw, on a second end surface of the oil scraping piece being formed at least one protrusion; and
a wiping member being disposed on the second end surface of the oil scraping piece and provided with a threaded portion for meshing with the surface of the screw, the protrusion of the oil scraping piece being abutted against the wiping member so as to form at least one radial through hole between the oil scraping piece and the wiping member into.

2. The dustproof device for a ball screw as claimed in claim 1 further comprising an absorber made of liquid-absorbing material is disposed between the dustproof device and the nut and is in contact with the surface of the screw, in a center of the absorber is formed a receiving hole for passage of the screw, the receiving hole is equal to or slightly smaller than a cross section of the screw, and the absorber is thicker than the oil scraping piece.

3. The dustproof device for a ball screw as claimed in claim 2, wherein the absorber is non-woven fabric, sponge, felt, or porous plastic.

4. The dustproof device for a ball screw as claimed in claim 1, wherein the wiping member is defined with a central receiving hole for passage of the screw, in the threaded portion is defined a plurality of discharging grooves for discharging chips, and in an outer periphery of the respective grooves of the wiping member is formed an annular groove for installation of an elastic member which makes the threaded portion of the wiping member abut closely against the surface of the screw.

5. The dustproof device for a ball screw as claimed in claim 1, wherein a plastic piece is disposed on an outer surface of the oil scraping piece for preventing liquid from entering the oil scraping piece.

6. The dustproof device for a ball screw as claimed in claim 1 further comprising an absorber, wherein the absorber, the oil scraping piece and the wiping member are fixed to the nut by a cover, and in the cover are defined radial grooves for discharging liquid.

7. The dustproof device for a ball screw as claimed in claim 5, further comprising an absorber, wherein the absorber, the oil scraping piece and the wiping member are fixed to the nut by a cover, and in the cover are defined radial grooves for discharging liquid.

8. The dustproof device for a ball screw as claimed in claim 1, wherein plural protrusions are equidistantly formed on the surface of the oil scraping piece and located around an axis of the screw.

9. A dustproof device for a ball screw being mounted on an end surface of a nut, and comprising:
an oil scraping piece formed with an oil scraping portion for contacting a surface of a screw of the ball screw; and
a wiping member being disposed at a side of the oil scraping piece and provided with a threaded portion for meshing with the surface of the screw, on a surface of the oil scraping piece being formed at least one protrusion, and the protrusion of the oil scraping piece being abutted against the wiping member so as to divide a space between the oil scraping piece and the wiping member into at least one radial through hole.

10. The dustproof device for a ball screw as claimed in claim 9, wherein an absorber made of liquid-absorbing material is disposed between the dustproof device and the nut and is in contact with the surface of the screw, in a center of the absorber is formed a receiving hole for passage of the screw, the receiving hole is equal to or slightly smaller than a cross section of the screw, and the absorber is thicker than the oil scraping piece.

11. The dustproof device for a ball screw as claimed in claim 10, wherein the absorber is non-woven fabric, sponge, felt, or porous plastic.

12. The dustproof device for a ball screw as claimed in claim 9, wherein the wiping member is defined with a central receiving hole for passage of the screw, in the threaded portion are defined a plurality of discharging grooves for discharging chips, and in an outer periphery of the respective grooves of the wiping member is formed an annular groove for installation of an elastic member which makes the threaded portion of the wiping member abut closely against the surface of the screw.

13. The dustproof device for a ball screw as claimed in claim 9, wherein a plastic piece is disposed on an outer surface of the oil scraping piece for preventing liquid from entering the oil scraping piece.

14. The dustproof device for a ball screw as claimed in claim 9, wherein the absorber, the oil scraping piece and the wiping member are fixed to the nut by a cover, and in the cover are defined radial grooves for discharging liquid.

15. The dustproof device for a ball screw as claimed in claim 11, wherein the absorber, the oil scraping piece and the wiping member are fixed to the nut by a cover, and in the cover are defined radial grooves for discharging liquid.

16. The dustproof device for a ball screw as claimed in claim 9, wherein plural protrusions are equidistantly formed on the surface of the oil scraping piece and located around an axis of the screw.
